(19) United States
(12) Patent Application Publication
(10) Pub. No.: US 2011/0246045 A1
(43) Pub. Date: Oct. 6, 2011

(54) METHOD FOR CONTROLLING A GLOW PLUG OF A COMBUSTION MACHINE OF A VEHICLE AND CONTROLLER FOR A GLOW PLUG OF COMBUSTION MACHINE OF A VEHICLE

(75) Inventor: Stefano Cassani, Torino (IT)

(73) Assignee: GM GLOBAL TECHNOLOGY OPERATIONS LLC, Detroit, MI (US)

(21) Appl. No.: 13/122,166

(22) PCT Filed: Jul. 27, 2009
(86) PCT No.: PCT/EP2009/005433

§ 371 Date: Jun. 17, 2011

(30) Foreign Application Priority Data
Oct. 2, 2008 (GB) 0818207.3

(51) Int. Cl. F02P 19/02

(52) U.S. Cl. 701/102

(57) ABSTRACT

A method is provided for controlling a glow plug of a combustion machine of a vehicle, the glow plug being driven by a first predetermined effective voltage, the first predetermined effective voltage being lower than the voltage of the battery of the vehicle when the combustion machine is running

### CROSS-REFERENCE TO RELATED APPLICATIONS

This application is a U.S. National-Stage entry under 35 U.S.C. § 371 based on International Application No. PCT/EP2009/005433, filed Jul. 27, 2009, which was published under PCT Article 21(2) and which claims priority to British Application No. 0818207.3, filed Oct. 2, 2008, which are all hereby incorporated in their entirety by reference.

### TECHNICAL FIELD

The invention relates to a method for controlling a glow plug of a combustion machine of a vehicle and to a controller for a glow plug of combustion machine of a vehicle.

### BACKGROUND

The WO 2007/033825 shows a control of a group of glow plugs for a diesel engine. The glow plugs are periodically connected with supply lines according to pulse-width modulated signals. To provide the glow plugs with the required energy, the voltage drop over the supply lines is calculated by the help of the measured glow plug current. This calculation is done for each glow plug individually to control its temperature. The method is well adapted for ceramic glow plugs of which the resistance strongly varies over the temperature. On the other hand, this method uses a calculation based on a number of measurements and estimations including the risk that the control of the temperature is wrong.

It is accordingly at least one object to provide an alternative glow plug controller unit that provides a more precise control of the temperature of the glow plugs. It is at least a further object of the invention to provide a method for controlling a glow plug more precisely. Furthermore, other objectives, desirable features and characteristics will become apparent from the subsequent summary and detailed description, and the appended claims, taken in conjunction with the accompanying drawings and this background.

### SUMMARY

A method is provided for controlling a glow plug of a combustion machine of a vehicle, the glow plug being driven by a first predetermined effective voltage, the first predetermined effective voltage being lower than the voltage of the battery of the vehicle when the combustion machine is running, the method comprising the following steps after the start of the vehicle and before the start of the combustion machine: a) estimating an initial temperature and/or an initial thermal energy of the glow plug, b) if the temperature and/or the thermal energy is below a predetermined value, heating the glow plug by a effective voltage higher than the first predetermined effective voltage, whereby in step a) the initial temperature and/or initial thermal energy of the glow plug is estimated by a temperature and/or thermal energy value that was stored in a step z), before the start of the vehicle, in which the temperature and/or the thermal energy of the glow plug was calculated by the electric power in the glow plug and the power dissipation of the glow plug. The step z) may be performed at any point in time before the particular start of the vehicle, for example during a previous stop of the vehicle or a previous run of the combustion machine.

This method permits to always get the desired glowing temperature and to maintain the glowing system quickness (and so engine readyness to start even in critical conditions like cold condition) without compromising the glow plug temperature.

In an embodiment, a step c) is provided, wherein the temperature and/or the thermal energy of the glow plug is calculated by the electric power in the glow plug and the power dissipation of the glow plug and the temperature and/or the thermal energy of the glow plug, step c) being applied at the same time and/or after step b).

A controller is also provided for a glow plug of a combustion machine of a vehicle, the glow plug being driven by a first predetermined effective voltage, the first predetermined effective voltage being lower than the voltage of the battery of the vehicle when the combustion machine runs, the controller comprising a start control device for controlling the glow plug after start of the vehicle and before start of the combustion machine, the start control device comprising: a first estimation device for estimating an initial temperature and/or the initial thermal energy of the glow plug, a heater for heating the glow plug in a heat-up mode by an effective voltage higher than the first predetermined effective voltage, if the temperature and/or the thermal energy is below a predetermined value, whereby the initial temperature and/or the initial thermal energy of the glow plug is estimated in the first estimation means by a temperature and/or thermal energy value that was stored in a memory, the memory being written before the start of the vehicle by a second estimation device, the second estimation device for calculating the temperature and/or the thermal energy of the glow plug by the electric power in the glow plug and the power dissipation of the glow plug.

### BRIEF DESCRIPTION OF THE DRAWINGS

The present invention will hereinafter be described in conjunction with the following drawing figures, wherein like numerals denote like elements, and:

FIG. 1 illustrates a diagrammatic view of a glow system circuitry;

FIG. 2 illustrates a typical Fast heat-up voltage profile;

FIG. 3 illustrates typical characteristics of a glow plug;

FIG. 4 illustrates a method for controlling a glow plug of a combustion machine of a vehicle after the start of the vehicle and before the start of the engine;

FIG. 5 illustrates a method for controlling a glow plug of a combustion machine of a vehicle after the stop of the engine;

FIG. 6 illustrates typical characteristics of a glow plug; and

FIG. 7 is an enlarged view of the temperature and the thermal energy of the glow plug versus time illustrated in FIG. 6.

### DETAILED DESCRIPTION

The following detailed description is merely exemplary in nature and is not intended to limit application and uses. Furthermore, there is no intention to be bound by any theory presented in the preceding background or summary or the following detailed description.

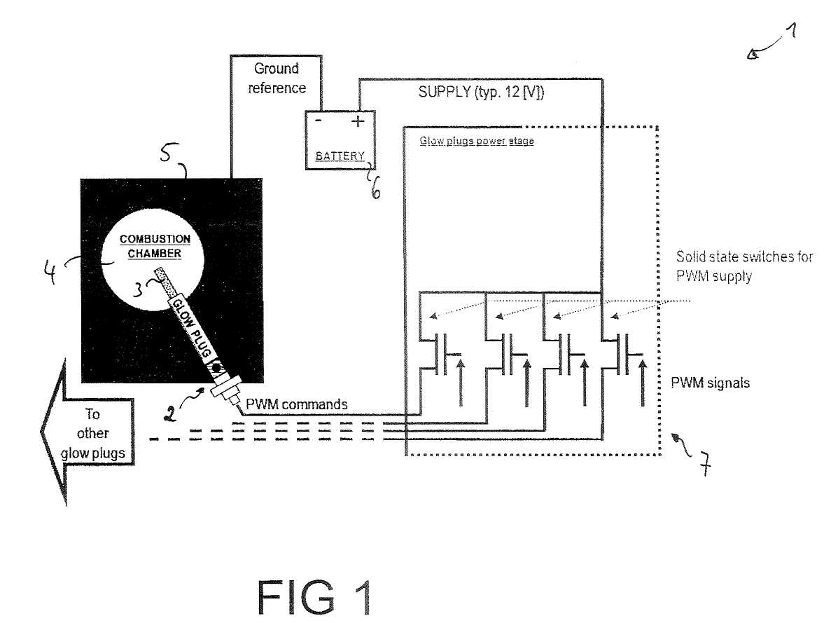

FIG. 1 illustrates a diagrammatic view of a glow system circuitry 1. A key component of the glow system circuitry 1 is the glow plug 2. The tip 3 of the glow plug 2, sticking out into the combustion chamber 4 arranged in the engine body 5, can rise up to high temperatures (above 900° C.) by means of an electrical to thermal power conversion.

Different technologies are available for glow plugs:
High/Low voltage glow plugs: in relation to the nominal supply voltage of the component, for example 11V for high voltage; the nominal voltage is needed to match the nominal temperature in still air condition,
Metallic/Ceramic glow plugs: in relation to technology used for the glow plug and the heating element.

High voltage glow plugs are typically supplied directly by the vehicle battery, the D.C. supply.

Low voltage glow plugs, as they have a nominal voltage lower than battery voltage (for example 7V for ceramic glow plugs), typically need a PWM (pulse width modulation) supply to get the correct voltage (effective or RMS voltage).

The glow system circuitry 1 illustrated in FIG. 1 includes a low voltage glow plug 2 and a PWM supply 7 connected to the battery 6.

As an engine control unit (ECU) is activated, i.e., by a driver key-on command, the control unit evaluates the possible need to switch-on the glow plug 2. If the glow plug 2 is switched on, then ECU communicates to the driver, i.e. through a specific board lamp, to await a certain time before commanding engine cranking: this is in order to get the glowing system ready and the glow plugs hot to support engine ignition before proceeding.

Generally, to reduce this time awaiting and to improve glowing system quickness, the low voltage glow plug 2 is supplied with a voltage higher than the nominal voltage: this can be done for a short time, just to reach as fast as possible the glow plug nominal temperature; then the voltage supply of the glow plug 2 is typically stepped down to the glow plug's nominal voltage to keep the temperature reached. This supply regulation is possible through the PWM supply 7 with different targets of effective voltages. The above-described method is also called “Fast heat-up” procedure.

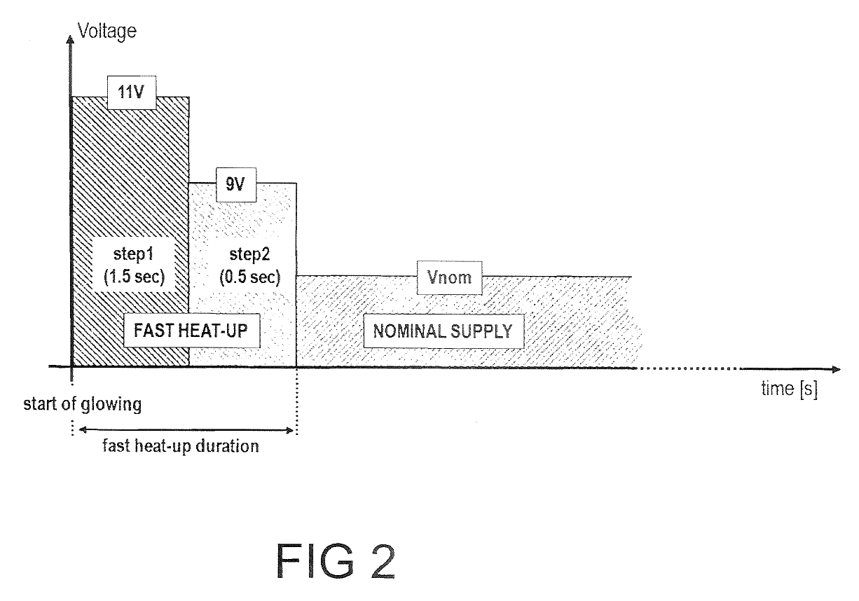

FIG. 2 illustrates a typical Fast heat-up voltage profile to be carried-out for such a Fast heat-up procedure for a ceramic glow plug. The time is shown on the abscissa and the effective voltage across the glow plug is shown on the ordinate.

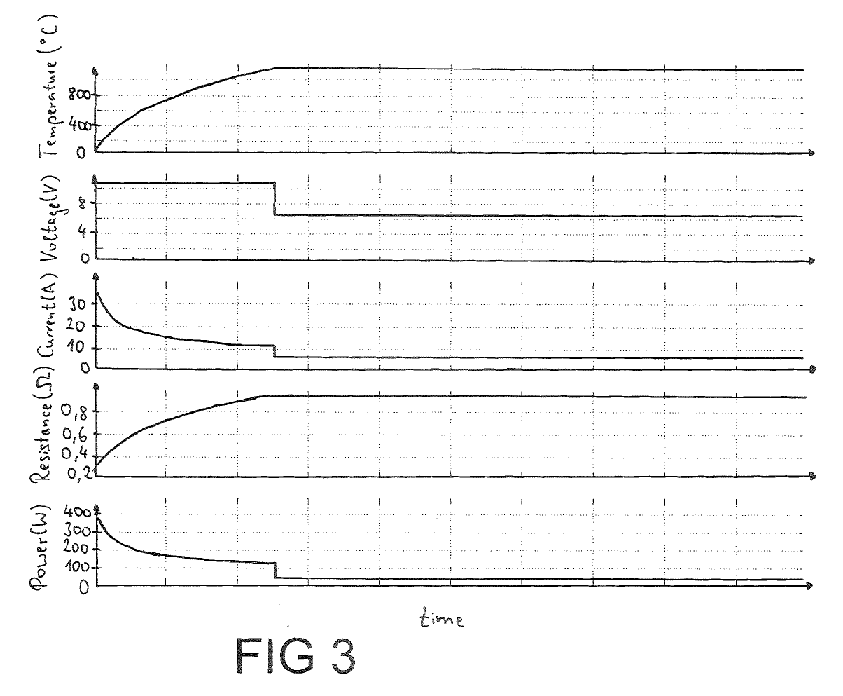

FIG. 3 illustrates typical characteristics of a glow plug, namely its temperature and its resistance versus time, and the effective voltage across the glow plug, the effective current into the glow plug and the thermal energy of the glow plug versus time.

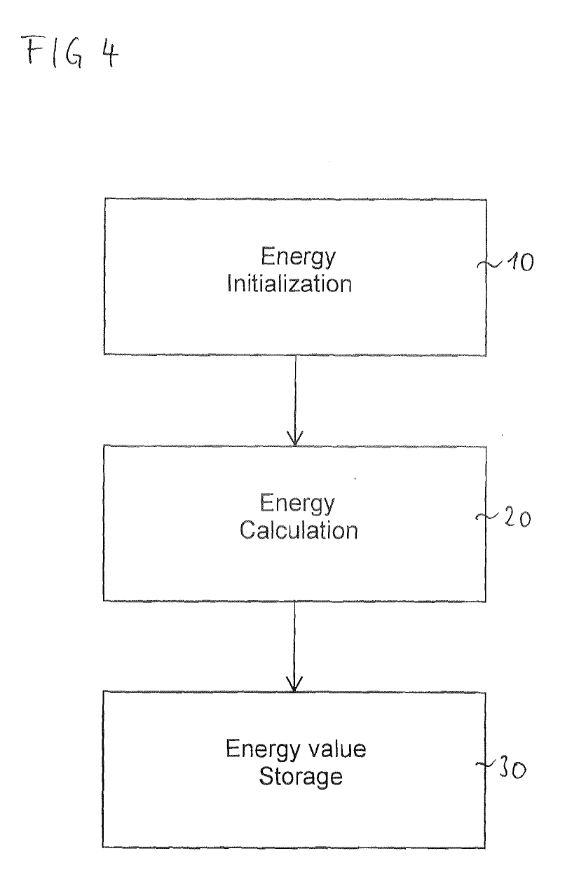

FIG. 4 illustrates a method for controlling a glow plug of a combustion machine of a vehicle after the start of the vehicle and before the start of the engine.

Several physical relationships will be used in the following, namely:
1a) Glow plug electrical power consumption:

p(t)=v(t)*i(t)
1b) Glow plug electrical power consumption:

$$p ( \text{?} ) = \frac{\text{?} {( \text{?} )}^{2}}{R ( \text{?} )}$$

$$\text{?} \text{indicates text missing or illegible when filed}$$

Where v(t) denotes the effective voltage across the glow plug, i(t) denotes the effective current into the glow plug and R(t) denotes the electrical resistance of the glow plug.
2) Glow plug energy content:

$$\text{?} ( \text{?} ) = {\int }_{0}^{\text{?}} p ( \text{?} )$$

$$\text{?} \text{indicates text missing or illegible when filed}$$

3a) Glow plug energy content after time T:

$$\text{?} ( \text{?} ) = {\int }_{0}^{\text{?}} p ( \text{?} ) d \text{?} = {\int }_{0}^{\text{?}} \text{?} ( \text{?} ) * \text{?} ( \text{?} ) d \text{?}$$

$$\text{?} \text{indicates text missing or illegible when filed}$$

3b) Glow plug energy content approximation after time T:

$$\text{?} ( \text{?} ) = {\int }_{0}^{\text{?}} \frac{\text{?} {( \text{?} )}^{2}}{\text{?} ( \text{?} )} d \text{?} ≅ \frac{1}{{R}_{m}} {\int }_{0}^{\text{?}} \text{?} {( \text{?} )}^{2} d \text{?}$$

$$\text{?} \text{indicates text missing or illegible when filed}$$

Where Rm denotes a mean value of the electrical resistance of the glow plug determined through experimental test.

The temperature rise up, during the Fast heat-up procedure, is linked to the energy content of the glow plug due to electrical power supply.

The energy increase versus time can be calculated using electrical measurements. At least one of the two electrical parameters are available for ECU calculations:
Effective voltage v(t) applied to the glow plug
Effective current i(t) flowing through the glow plug

A first method for the energy rise-up calculation is based on the assumption, that the effective voltage and current measurements both are available. Then, reference relationships 1a) and 3a) are used.

A second method for the energy rise-up calculation is based on the assumption, that only the effective voltage measurement is available. Then, reference relationships 1b) and 3b) are used. The value of Rm appearing in relation 3b) is stored in the control unit.

Both methods include the following process steps: An initial value of the energy is set at the start in step 10 either: to a previously calculated value if available, to null value if the glow plug is recognized to be in a reference condition, to a maximum value if none of the previous cases is applicable.

The reference condition may be the condition when is vehicle is produced. At this time, the temperature is estimated to be approximately 10 degree C. Differences in the ambient temperature can be neglected because the glow temperature is between approximately 800 degree Celsius and approximately 1000 degree Celsius.

The energy is then calculated in step 20 through power integration if all of the following conditions are met:
the engine is stopped and
the voltage applied across the glow plug is higher than the nominal voltage.

Once the calculation has started, as soon as one of the above conditions is not met any longer, the energy calculation is frozen and the actual value of the energy is stored in step 30.

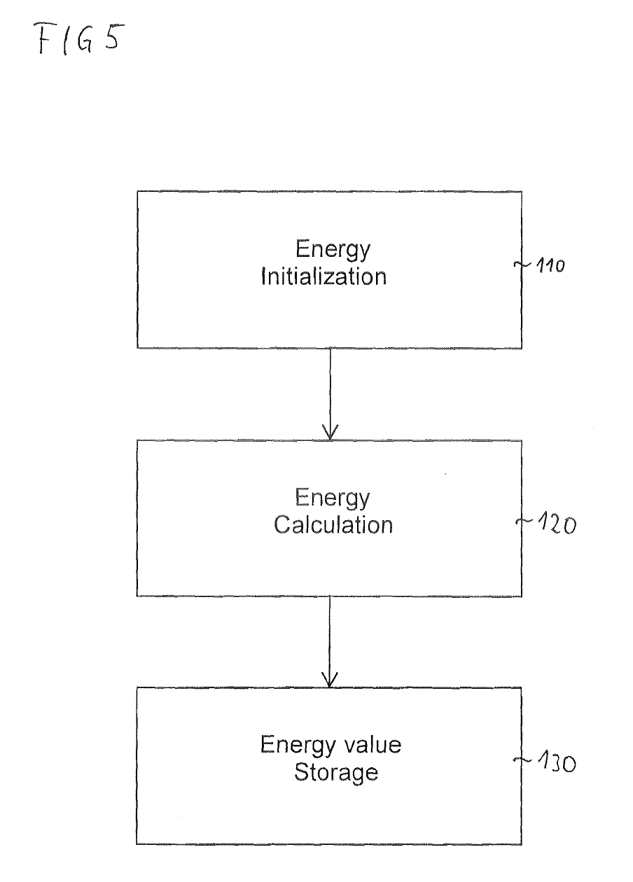

FIG. 5 illustrates a method for controlling a glow plug of a combustion machine of a vehicle after the stop of the engine. The temperature fall down, during glow plug cooling (neither electrical supply nor combustion heat), is linked to the energy content fall down due to heat exchange with the environment.

The energy decrease versus time can be calculated starting from a set of numerical values, recognizable through experimental test and settable in the control, representing energy gradient as dependent on energy content.

A first method for the energy fall down calculation is based on the assumption, that p(t) due to heat exchange with environment is recognizable through experimental test as dependent, mainly but not only, on the glow plug energy content. Then, reference relationship 3a) is used.

The method includes the following process steps:

An initial value of the energy is set at the start in step 110 either to a value computed at rise-up end if Fast heat-up is performed and no engine running occurred later on or to a value settable in the control unit, recognizable through experimental test, and related to the glow plug thermal status due to power supply and/or combustion heat.

The energy is then calculated in step 120 through power integration if all of the following conditions are met:
the engine is stopped and
the voltage applied across the glow plug is zero.

Once the calculation has started, as soon as one of the above conditions is not met any longer, the energy calculation is frozen and the actual value of the energy is stored in step 130.

The energy rise-up and energy fall down calculations are carried on according to the glow plug supply voltage and to the engine status (running or stopped) as previously described in relation with FIG. 4 and FIG. 5. A fast heat-up voltage profile, generally indicated in terms of effective voltage versus time profile, is applied to the glow plugs until the energy content rises up to a maximum threshold set in the control: this threshold is recognizable through experimental test and corresponds to the glow plug nominal temperature and could depend on some engine parameters (i.e., engine coolant temperature).

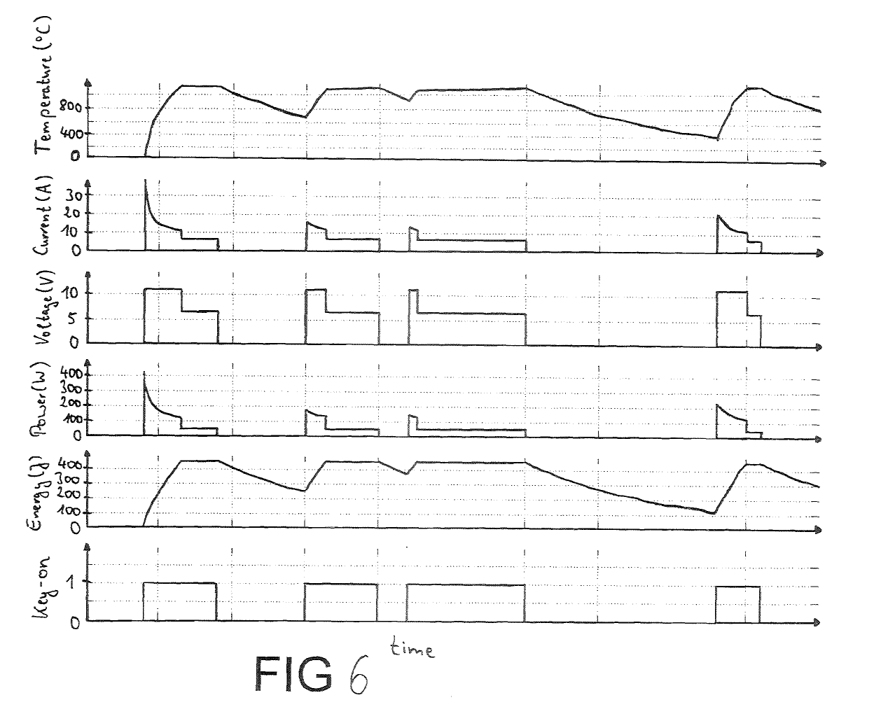

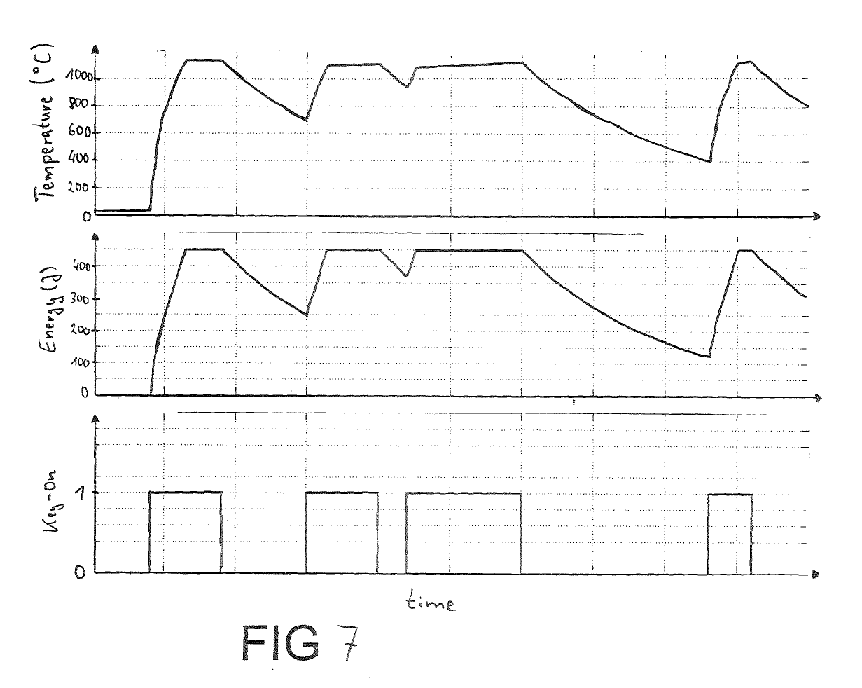

As illustrated in FIG. 6 and FIG. 7, this kind of management permits to always get the desired glowing temperature, and to maintain the glowing system quickness (and so engine readyness to start even in critical conditions like cold condition) without compromising the glow plug temperature.

As a result of this management the Fast heat-up procedure applied to the glow plugs is varied according to the glow plug's thermal status (represented by the energy content).

Special benefits of this management can be observed with un-predictable driver operations such as consecutive key-on/key-off/key-on.

FIG. 6 illustrates typical characteristics of a glow plug, namely its temperature versus time, and the effective voltage across the glow plug, the effective current into the glow plug, the dissipated power and the thermal energy of the glow plug versus time. Moreover, the “key-on” periods, i.e. the phases at which the vehicle is started, are illustrated in the lowermost graph by the value “1”. The glow plug is controlled according to the methods of the invention described in relation with FIG. 4 and FIG. 5.

FIG. 7 is an enlarged view of the temperature and the thermal energy of the glow plug versus time illustrated in FIG. 6. Moreover, the “key-on” periods, i.e. the phases at which the vehicle is started, are illustrated in the lowermost graph by the value “1”.

While at least one exemplary embodiment has been presented in the foregoing summary and detailed description of the invention, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment of the invention, it being understood that various changes may be made in the function and arrangement of elements described in an exemplary embodiment without departing from the scope as set forth in the appended claims and their legal equivalents.

1. A method for controlling a glow plug of a combustion machine of a vehicle, the glow plug driven by a first predetermined effective voltage that is lower than a voltage of the battery of the vehicle when the combustion machine is running, the method comprising:
calculating a thermal energy of the glow plug with at least an electric power in the glow plug and a power dissipation of the glow plug;
storing a thermal energy value before a start of the vehicle;
estimating an initial thermal energy of the glow plug with at least a thermal energy value stored before the start of the vehicle, in which: and
heating the glow plug by an effective voltage higher than the first predetermined effective voltage if the initial thermal energy is below a predetermined value.

2. The method according to claim 1, further applying the thermal energy of the glow plug at substantially the same time as the heating.

3. A controller for a glow plug of a combustion machine of a vehicle, the glow plug driven by a first predetermined effective voltage that is lower than a voltage of the battery of the vehicle when the combustion machine runs, comprising:
a memory configured to store a thermal energy value before the start of the vehicle by a second estimation device; and
a start control device configured to control the glow plug after start of the vehicle and before start of the combustion machine, the start control device comprising:
a first estimation device configured to estimate an initial thermal energy of the glow plug, the first estimation device configured to estimate the initial thermal energy of the glow plug with the thermal energy value stored in the memory;
a heater configured to heat the glow plug in a heat-up mode by an effective voltage higher than the first predetermined effective voltage, if the thermal energy is below a predetermined value;
a second estimation device configured to estimate the thermal energy of the glow plug with the electric power in the glow plug and the power dissipation of the glow plug.

4. The method according to claim 1, wherein the thermal energy is a temperature.

5. The method according to claim 1, further comprising applying the thermal energy of the glow plug at substantially the same time as the heating.

6. The controller according to claim 3, wherein the thermal energy is a initial temperature.
